(19) United States
(12) Patent Application Publication
(10) Pub. No.: US 2026/0359707 A1
(43) Pub. Date: Nov. 12, 2026

(54) SYSTEMS AND METHODS FOR ROUTING MACHINE LEARNING MODEL QUERIES

(71) Applicant: PwC Product Sales LLC, New York, NY (US)

(72) Inventors: Arit Kumar BISHWAS, Fremont, CA (US); Mayank SAINI, Rajasthan (IN); Ryan ARMSTRONG, Waco, TX (US)

(73) Assignee: PwC Product Sales LLC, New York, NY (US)

(21) Appl. No.: 19/200,198

(22) Filed: May 6, 2025

(51) Int. Cl. G06N 20/00; G06F 16/45

(52) U.S. Cl. CPC G06N 20/00; G06F 16/45

(57) ABSTRACT

A system for routing queries to machine learning models is provided. The system receives a query based on one or more of a text input, an audio input, an image input, an image-generation input, a video input, or a document input; and determines a query classification comprising a text classification indicating a text input; a non-text classification indicating an input based on one or more of audio, images, image-generation, videos, or documents; or both. Based on the query classification, the system routes the query to at least one of: a text-processing machine learning model selected based on one or more of a complexity or a task associated with the text input; or a machine learning model configured for at least one of audio processing, image processing, image generation, video processing, or multimodal processing. The system generates an output based on processing by the model to which the query was routed.

### FIELD

The present disclosure relates generally to machine learning model query handling and specifically to the routing of queries to one or more models.

### BACKGROUND

Known techniques for processing machine learning model queries may rely on general-purpose large language models (LLMs) such as ChatGPT, Gemini, and/or Claude. Such LLMs may be capable of generating high-quality, detailed responses to address a range of tasks including summarization, translation, code generation, and/or document understanding.

Existing techniques may process all queries received, regardless of query complexity or associated task, using a single general-purpose LLM, based for example on a default system setting and/or on a manual selection made by a user. For example, in systems such as ChatGPT or Gemini, a user query may be processed by an advanced general-purpose LLM without any automated assessment of the query's complexity or resource requirements.

### SUMMARY

As noted above, known techniques for processing machine learning model queries may rely on general-purpose large language models for generating high-quality, detailed responses to address a range of tasks including summarization, translation, code generation, and/or document understanding. However, such models may be computationally intensive and can incur high operational costs, even when applied to relatively simple tasks.

Existing techniques may process all queries received, regardless of query complexity or associated task, using a single general-purpose LLM, based for example on a default system setting and/or on a manual selection made by a user. For example, in systems such as ChatGPT or Gemini, a user query may be processed by an advanced general-purpose LLM without any automated assessment of the query's complexity or resource requirements. As a result, even straightforward queries that could be adequately addressed by smaller or task-specific models are instead processed by general-purpose LLMs, increasing computational overhead.

Known machine learning pipelines may be text-focused with limited support for multiple query modalities including, for example, audio, image, video, and/or document inputs. When such inputs are supported, processing may still occur within the same premium general-purpose LLM, rather than being routed to specialized or cost-effective alternatives. As a result, associated computations may take longer and involve a higher compute cost, especially for narrow-scope single modality or multimodal tasks that do not involve the full capabilities of a general-purpose LLM. For example, extracting textual content from an image and performing basic natural language analysis on the extracted text may not involve the reasoning and/or generative capabilities of a general-purpose LLM.

Accordingly, there is a need for improved systems and methods for efficient and intelligent query routing in machine learning systems.

Disclosed systems and methods may support efficient and intelligent query routing by analyzing incoming user inputs to determine the modality (e.g., text, image, audio, video, and/or document), complexity, and/or task category of each query. As discussed above, known techniques may default to using general-purpose LLMs such as GPT-40, regardless of whether the task warrants such computational expense. This results in inefficient resource allocation, especially for queries involving straightforward tasks and/or single-modality inputs. In contrast, disclosed systems may utilize a modular automated framework capable of analyzing incoming text, audio, video, image, and/or document-based queries, routing queries by selecting the most appropriate machine learning model or set of models for processing and output generation. By matching each input to an optimized processing path, this approach may reduce unnecessary compute cycles, improve system throughput, and/or conserve computational resources by leveraging lower-cost models for routine tasks.

An exemplary system may receive a user-defined cost preference, which may include a preference for use of resource-efficient small-scale machine learning models, high-performance machine learning models, and/or task-specific machine learning models. In accordance with the received user-defined cost preference, an exemplary system may perform a classification step to determine whether one or more received queries include a text-based input and/or a non-text input. This classification may determine a routing path of the one or more queries. A preprocessing stage may normalize input data, for example by transcribing audio files and/or segmenting documents, to enable more accurate downstream classification. Incorporating such preprocessing may simplify and enhance referencing multimodal content during follow-up interactions.

Although paid (closed-source) models may often be high-performance or large-scale, substantial open-source models may also exist—for instance, the meta-llama/Llama-3.3-70B-Instruct model available openly. Thus, cost preference may consider model accessibility, availability, and openness. Open-source models may be freely accessible via platforms such as Hugging Face or Ollama.

If the one or more queries are determined to include a non-text input, the one or more queries may be routed to one or more modality-specific machine learning models. The one or more queries may include a simple query and/or may include a complex query, corresponding to orchestration across multiple machine learning models and/or modalities to fulfill the requested task comprehensively. These models may be selected from among audio-processing machine learning models, image-processing machine learning models, image-generation machine learning models (e.g., DALL-E 3), video-processing machine learning models, document-processing machine learning models, and/or multimodal machine learning models. Machine learning model selection within this modality-specific routing path may reflect multiple factors including, for example, alignment with task-specific capabilities, domain relevance, computational constraints, and/or the user's cost preference. An exemplary system may also support routing multimodal queries, for example a combination of a text-based input with a non-text input, by distributing tasks and/or subtasks corresponding to each modality to one or more of the above-mentioned specialized machine learning models and/or to a multi-model Mixture-of-Experts system.

If the one or more queries are determined to include a text-based input, the one or more queries may be routed to one or more text-processing machine learning models. Routing within this text-processing routing path may be guided by evaluation of the complexity of the input, for example routing highly complex inputs to a high-performance LLM such as GPT-40. Less complex inputs may be processed to identify one or more task types (e.g., summarization, classification, Q&A, and/or rewriting). Task classification may rely on task-specific machine learning model output, keyword detection, syntactic pattern recognition, and/or embedding-based semantic matching.

An exemplary system may assign weights to one or more candidate machine learning models based on past model performance, compute cost, and/or alignment with the determined one or more task types generated by the above-described classification methods. Kernel density estimation may be applied to smooth noisy weight assignments and generate continuous probability distributions to guide final machine learning model selection. In the event that task and/or weight determinations for a particular machine learning model generated by different classification methods are uncertain and/or inconsistent, an exemplary system may perform a secondary classification process and/or utilize a fallback machine learning model.

Fallback routing may, in some embodiments, be triggered by low confidence in a generated output response and/or by user feedback or automated feedback indicating unsatisfactory performance. If an exemplary system determines that a machine learning model's output response falls below a confidence threshold, the corresponding one or more queries may be rerouted to a higher-performance machine learning model as a fallback. Similarly, if a user (or assessment system) indicates that a response output is incorrect and/or insufficient, the system may escalate the corresponding one or more queries to a higher-performance machine learning model. In some implementations, the system may take user feedback on each output, and if the feedback falls below a certain threshold, the system may be configured to resort to fallback models (such as GPT-based models).

In some embodiments, a system for routing queries to one or more machine learning models is provided, the system comprising one or more processors and memory storing instructions that, when executed by the one or more processors, cause the system to: receive one or more queries comprising at least one input selected from a group consisting of: a text-based input, an audio-based input, an image-based input, an image generation-based input, a video-based input, and a document-based input; determine one or more classifications corresponding to the one or more queries, wherein the one or more classifications comprise at least one of: a text classification, indicating that at least one of the one or more queries comprises a text-based input; or a non-text classification, indicating that at least one of the one or more queries comprises at least one input selected from a group consisting of: an audio-based input, an image-based input, an image generation-based input, a video-based input, and a document-based input; based on the determined one or more classifications, route the one or more queries to at least one of: one or more text-processing machine learning models, wherein routing the one or more queries to the one or more text-processing machine learning models comprises selecting one of the text-processing machine learning models based on a complexity associated with the text-based input, one or more tasks associated with the text-based input, or both; or at least one machine learning model selected from a group consisting of: one or more audio-processing machine learning models, one or more image-processing machine learning models, one or more image-generation machine learning models, one or more video-processing machine learning models, and one or more multimodal machine learning models; and generate an output response based on processing performed by one or more machine learning models to which the one or more queries were routed.

In some embodiments, the instructions further cause the system to, prior to receiving one or more queries, receive a cost preference selection associated with processing the one or more queries, wherein the cost preference specifies at least one machine learning model selected from a group consisting of: one or more small-scale machine learning models, one or more high-performance machine learning models, and one or more task-specific machine learning models. In some embodiments, routing the one or more queries further comprises selecting one or more machine learning models based on the determined one or more classifications and the received cost preference selection. In some embodiments, selecting the one or more text-processing machine learning models comprises: determining that the complexity associated with the text-based input meets a complexity threshold; and in accordance with determining that the complexity associated with the text-based input meets the complexity threshold, selecting one or more high-performance machine learning models. In some embodiments, selecting the one or more text-processing machine learning models comprises: determining that the complexity associated with the text-based input does not meet a complexity threshold; in accordance with determining that the complexity associated with the text-based input does not meet the complexity threshold: assigning one or more weights to a plurality of machine learning models based on at least one parameter selected from a group consisting of: model performance, computational cost, and the one or more tasks associated with the text-based input; and selecting the one or more text-processing machine learning models based on the one or more weights. In some embodiments, the instructions further cause the system to determine the one or more tasks associated with the text-based input. In some embodiments, determining the one or more tasks associated with the text-based input is based on an output from a task-specific machine learning model. In some embodiments, determining the one or more tasks associated with the text-based input is based on one or more task categories associated with the text-based input. In some embodiments, the one or more task categories comprise at least one task category selected from a group consisting of: summarization, translation, code generation, and mathematical reasoning. In some embodiments, the instructions further cause the system to determine the one or more task categories associated with the text-based input based on one or more task-related keywords in the text-based input and one or more syntactic features of the text-based input. In some embodiments, determining the one or more tasks associated with the text-based input comprises: transforming the text-based input into one or more vector representations using a machine learning-based embedding model; comparing the one or more vector representations to one or more vector representations corresponding to one or more task categories; and determining one or more probabilities corresponding to the likelihood that the text-based input is associated with the one or more task categories. In some embodiments, the one or more task categories comprise at least one task category selected from a group consisting of: summarization, translation, code generation, and mathematical reasoning. In some embodiments, routing the one or more queries to the one or more text-processing machine learning models comprises: identifying, within the one or more queries, one or more dependent subtasks and one or more independent subtasks, wherein the one or more dependent subtasks correspond to sequential execution and the one or more independent subtasks correspond to parallel execution; routing the one or more independent subtasks to a plurality of task-specific machine learning models for parallel processing; and routing the one or more dependent subtasks to one or more task-specific machine learning models for sequential processing, wherein at least one of the one or more dependent subtasks is executed based on an output generated from a prior dependent subtask. In some embodiments, the instructions further cause the system to aggregate output responses generated by processing the one or more independent subtasks and the one or more dependent subtasks using a model aggregation system configured to combine outputs from multiple machine learning models based on task-specific criteria to generate a final output response. In some embodiments, the model aggregation system is configured to assign one or more task-specific weights to the outputs from the multiple machine learning models based on relevance to an intent associated with the one or more queries, wherein the generated final output response is based on the intent. In some embodiments, the instructions further cause the system to: determine that one or more confidence scores associated with the routing of the one or more queries do not meet a confidence threshold; and in accordance with determining that the one or more confidence scores do not meet the confidence threshold, reroute the one or more queries to one or more alternative machine learning models, wherein the one or more alternative machine learning models are selected to provide higher performance relative to the originally routed one or more machine learning models. In some embodiments, the instructions further cause the system to: receive feedback indicating that the output response does not meet a satisfaction criterion; and in accordance with receiving the feedback, reroute the one or more queries to one or more alternative machine learning models to generate a revised output response, wherein the one or more alternative machine learning models are selected to provide higher performance relative to the originally routed one or more machine learning models. In some embodiments, the instructions further cause the system to: receive one or more follow-up queries associated with the output response, wherein the output response was generated based on processing performed by the at least one machine learning model selected from the group consisting of: the one or more audio-processing machine learning models, the one or more image-processing machine learning models, the one or more image-generation machine learning models, the one or more video-processing machine learning models, and the one or more multimodal machine learning models; and route, based on the output of a task-specific machine learning model, the one or more follow-up queries to the at least one machine learning model that generated the output response. In some embodiments, the instructions further cause the system to route, based on the output of the task-specific machine learning model, the one or more follow-up queries to at least one other machine learning model selected from the group consisting of: the one or more audio-processing machine learning models, the one or more image-processing machine learning models, the one or more image-generation machine learning models, the one or more video-processing machine learning models, or the one or more multimodal machine learning models. In some embodiments, the instructions further cause the system to route, based on the output of the task-specific machine learning model, the one or more follow-up queries to a model aggregation system configured to combine outputs from multiple machine learning models based on task-specific criteria to generate a final output response. In some embodiments, routing the one or more follow-up queries to the at least one machine learning model that generated the output response comprises: retrieving contextual information associated with a modality of the one or more queries; and providing the retrieved contextual information to the at least one machine learning model that generated the output response. In some embodiments, the contextual information associated with the modality of the one or more queries comprises at least one element selected from a group consisting of: a stored user query, a stored model response, stored metadata, and a stored semantic embedding.

In some embodiments, a method for routing queries to one or more machine learning models is provided, the method performed by a system comprising memory and one or more processors, the method comprising: receiving one or more queries comprising at least one input selected from a group consisting of: a text-based input, an audio-based input, an image-based input, an image generation-based input, a video-based input, and a document-based input; determining one or more classifications corresponding to the one or more queries, wherein the one or more classifications comprise at least one of: a text classification, indicating that at least one of the one or more queries comprises a text-based input; or a non-text classification, indicating that at least one of the one or more queries comprises at least one input selected from a group consisting of: an audio-based input, an image-based input, an image generation-based input, a video-based input, and a document-based input; based on the determined one or more classifications, routing the one or more queries to at least one of: one or more text-processing machine learning models, wherein routing the one or more queries to the one or more text-processing machine learning models comprises selecting one of the text-processing machine learning models based on a complexity associated with the text-based input, one or more tasks associated with the text-based input, or both; or at least one machine learning model selected from a group consisting of: one or more audio-processing machine learning models, one or more image-processing machine learning models, one or more image-generation machine learning models, one or more video-processing machine learning models, and one or more multimodal machine learning models; and generating an output response based on processing performed by one or more machine learning models to which the one or more queries were routed.

In some embodiments, a non-transitory computer readable storage medium storing instructions for routing queries to one or more machine learning models is provided, wherein the instructions, when executed by one or more processors of an electronic device, cause the device to: receive one or more queries comprising at least one input selected from a group consisting of: a text-based input, an audio-based input, an image-based input, and image generation-based input, a video-based input, and a document-based input; determine one or more classifications corresponding to the one or more queries, wherein the one or more classifications comprise at least one of: a text classification, indicating that at least one of the one or more queries comprises a text-based input; or a non-text classification, indicating that at least one of the one or more queries comprises at least one input selected from a group consisting of: an audio-based input, an image-based input, an image generation-based input, a video-based input, and a document-based input; based on the determined one or more classifications, route the one or more queries to at least one of: one or more text-processing machine learning models, wherein routing the one or more queries to the one or more text-processing machine learning models comprises selecting one of the text-processing machine learning models based on a complexity associated with the text-based input, one or more tasks associated with the text-based input, or both; or at least one machine learning model selected from a group consisting of: one or more audio-processing machine learning models, one or more image-processing machine learning models, one or more image-generation machine learning models, one or more video-processing machine learning models, and one or more multimodal machine learning models; and generate an output response based on processing performed by one or more machine learning models to which the one or more queries were routed.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1A depicts an exemplary system for routing queries to one or more machine learning models, according to some embodiments.

FIG. 1B depicts an exemplary process for routing queries to one or more machine learning models, according to some embodiments.

FIG. 2 depicts an exemplary process for routing text-based queries to one or more machine learning models, according to some embodiments.

FIG. 3 depicts an exemplary process for routing text-based queries to one or more machine learning models for sequential and/or parallel processing, according to some embodiments.

FIG. 4 depicts for routing follow-up queries to one or more machine learning models, according to some embodiments.

FIG. 5 depicts an exemplary computing system, according to some embodiments.

### DETAILED DESCRIPTION

Disclosed herein are systems and methods for intelligent and cost-efficient routing of machine learning model queries based on query type, task complexity, and/or user-defined preferences. Unlike known techniques that may route all inputs, regardless of modality and/or complexity, to general-purpose LLMs, disclosed methods may involve early classification and/or analysis to direct each query to an appropriate machine learning model. Disclosed methods may determine whether a query includes text, image, audio, video, and/or document inputs, and select one or more appropriate machine learning models accordingly. Received queries may be further analyzed to determine their complexity and/or associated task type (e.g., summarization, code generation, and/or document understanding), thereby enabling more precise and/or economical machine learning model selection.

Disclosed systems may support handling of both single-modality and multimodal inputs. For non-text inputs, such as audio and/or images, received queries may be routed to specialized models such as Whisper for transcription and/or CLIP for image interpretation. If the input includes both text and non-text attachments, an exemplary system may decompose the one or more queries and route query components to appropriate modules, executing them in sequence and/or in parallel based on dependencies between query components. For example, specific capabilities that may be supported by disclosed systems include coding assistance, mathematical problem-solving, and/or text summarization.

In contrast, text-based inputs may be assessed using one or more task classification techniques including keyword detection, structural analysis, and/or semantic embedding comparisons. An exemplary system may assign one or more weights to a particular machine learning model based on model performance history, computational efficiency, and/or alignment with task classifications determined using one or more of the above techniques. For example, a machine learning model may be chosen based on its suitability for a specific type of task (e.g., coding, summarization, and/or mathematical queries). Kernel density estimation may be used to normalize the one or more weights into continuous probability distributions, improving the reliability of routing decisions particularly in ambiguous cases.

Based on query complexity, and/or on the assigned one or more weights and/or probability distributions, an exemplary system may route the input to task-specific and/or domain-specific machine learning models, and/or to a high-performance LLM such as GPT-40. If an exemplary system assigns an output response generated by a machine learning model a low confidence score and/or if an output response receives negative user feedback, fallback mechanisms may allow rerouting of the corresponding one or more queries to higher-performance machine learning models.

Relative to known techniques, disclosed systems and methods mitigate the computational overhead and/or response delays that may be associated with exclusive reliance on one or more general-purpose LLMs. Rather than assigning all queries to high-performance machine learning models such as GPT-40 and/or Gemini, disclosed systems and methods may use a modular framework to process queries using one or more specialized and/or cost-efficient machine learning models. Relative to processing by a general-purpose LLM, disclosed methods may yield equivalent or higher performance processing of complex, domain-specific, and/or multimodal queries while conserving computational resources for simpler tasks.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

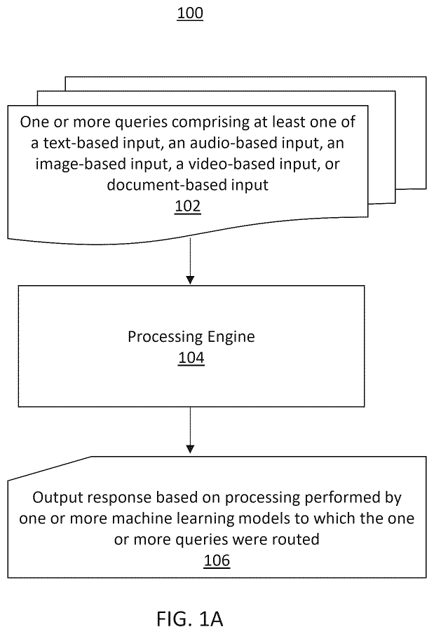

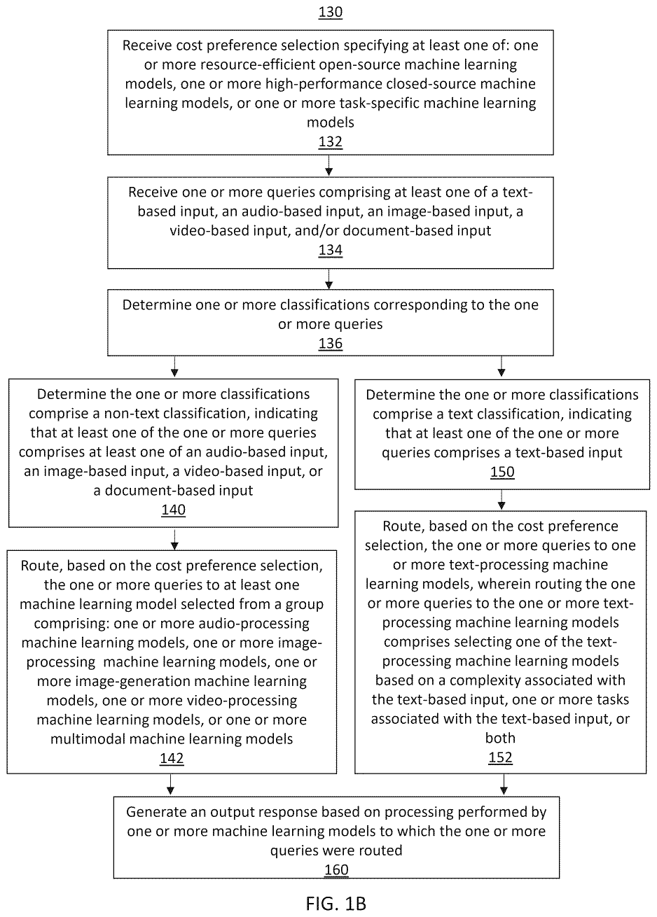

FIG. 1A depicts an exemplary system 100 for routing and processing single-modality or multimodal queries using one or more machine learning models. As depicted, system 100 may receive one or more queries 102, process the one or more queries using a processing engine 104, and generate a corresponding output response 106. System 100 may support routing and processing of a wide range of inputs including, for example, text-based queries, audio files, video streams, image uploads, image generation requests, and/or document-based inputs such as PDFs and/or word-processing files. In some implementations, one or more queries 102 may include only a single modality, for example a natural language prompt. In other implementations, one or more queries 102 may include multiple modalities such as a text-based input accompanied by one or more attachments, for example an image attachment and/or a video attachment. In some implementations, system 100 may receive multi-part queries with various dependencies among components. For example, system 100 may receive a request that involves extracting text from an uploaded image and subsequently analyzing the extracted text to summarize and/or classify the content of the image.

Processing engine 104 may include one or more processors configured to execute a set of routing and/or inference operations across one or more machine learning models. In some implementations, processing engine 104 may include high-performance computing elements, such as general-purpose CPUs, GPUs, and/or AI accelerators (for example, Google TPUs and/or Intel Gaudi processors), configured to execute transformer-based models and/or perform data matching and/or retrieval tasks. Such tasks may include analyzing patterns in input data, comparing vector embeddings, and/or selecting one or more machine learning models based on model performance, model cost, and/or similarity between input data and previously processed examples. In some implementations, processing engine 104 may run one or more machine learning models locally, including open-source machine learning models (for example LLaMA and/or Mixtral), closed-source machine learning models (for example GPT-40 and/or Claude), and/or traditional machine learning models (for example YOLO and/or CLIP). In other implementations, processing engine 104 may include a distributed cloud-based infrastructure executing machine learning model inference remotely.

Processing engine 104 may include embedded software modules for handling machine learning model selection, task-specific routing, subtask decomposition, and/or follow-up query handling. Such modules may include, for example, a classification module for identifying query modality and/or task category, a matching module for assigning queries to appropriate machine learning models based on semantic embeddings for example, a decomposition module for segmenting complex queries into dependent and independent subtasks, and/or a follow-up handling module configured to determine contextual relevance and whether to continue use of a current machine learning model or to reroute to a different model.

Output response 106 may include one or more results generated by one or more selected machine learning models to which one or more queries 102 were routed. Output 106 may take various forms depending on the modality and/or task associated with one or more queries 102. For example, output response 106 may include natural language text, extracted metadata, summaries, object detection results, code snippets, and/or cross-modal answers generated following processing of multimodal queries. In some implementations, output response 106 may be generated by combining the results of multiple machine learning model modules operating in sequence and/or in parallel. For example, output response 106 may be the result of extracting text from an image followed by summarizing the text (sequential processing), and/or simultaneously transcribing audio and analyzing associated metadata (parallel processing). Output response 106 may also represent a response to a follow-up query generated using a model aggregation system integrating a plurality of machine learning models with different areas of expertise and/or task-based specializations. For example, generating output response 106 to a follow-up query may involve combining outputs from a document-analysis model and a language-generation model to answer a question about the contents of an uploaded PDF document.

FIG. 1B depicts an exemplary process 130 for routing and processing user queries by selecting machine learning models based on one or more factors including, for example, cost preferences, input modalities, and/or task complexity. As shown, process 130 may begin at step 132 with the receipt of a cost preference selection. The cost preference selection may specify one or more categories of machine learning models, including open-source machine learning models that may include resource-efficient, small-scale machine learning models such as small language models (e.g. Mistral, LLaMa, and/or Falcon); closed-source, high-performance machine learning models (e.g. GPT-40, Gemini, and/or Claude); traditional task-specific machine learning models (e.g., YOLO); and/or modern transformer-based task-specific machine learning models (e.g., CLIP and/or Whisper specialized for vision and/or speech tasks respectively). In some implementations, the cost preference selection may be defined per session and/or per query, and/or may be adjusted automatically based on a balance between response quality and computational cost. For example, system 100 may default to lower-cost open-source machine learning models unless task complexity exceeds a predefined threshold, in which case system 100 may opt to process queries using a higher-cost, closed-source machine learning model.

The term “small-scale” may not inherently limit open-source models to smaller sizes or capabilities. Open-source machine learning models may not be constrained solely to resource-efficient or smaller language models (SLMs); many open-source models, such as large-scale variants like LLaMa or Falcon, may demonstrate significant scalability and resource efficiency. Furthermore, these models may be readily accessible and may often provide competitive, state-of-the-art performance on specialized tasks, including but not limited to coding, mathematical reasoning, and/or analytical processing, in comparison to prominent closed-source models such as GPT. For example, while models such as Mistral, LLaMa, and Falcon may be described as lightweight or efficient, their designation as small language models (SLMs) or large language models (LLMs) may depend on specific parameter configurations. Small language models (SLMs) may typically include fewer than 1 billion parameters and may be optimized for deployment in resource-constrained environments, such as edge devices or mobile platforms. These models may offer faster inference and lower compute costs while maintaining strong performance for tasks such as reasoning and summarization. For example, Phi-2 and Phi-3-small, developed by Microsoft, may demonstrate effective performance on common reasoning tasks despite their compact size.

Large language models (LLMs), by contrast, may include models with billions to trillions of parameters and may be capable of handling complex, multi-domain tasks with high accuracy. These models may require substantial computational resources and may include examples such as GPT-4 and Gemini 1.5 Pro, which are estimated to include over one trillion parameters. For instance, the Mistral family of models may include variants such as Mistral 7B, which may contain approximately 7 billion parameters and therefore may fall at the boundary between traditional SLMs and LLMs. While more efficient than models with hundreds of billions of parameters, such models may still be considered substantial in size depending on deployment context.

At step 134, system 100 may receive one or more queries, each comprising at least one of a text-based input, an audio-based input, an image-based input, an image generation-based input, a video-based input, and/or a document-based input. In some implementations, the one or more queries may include combinations of these modalities. For example, the one or more queries may include a text prompt referencing an uploaded PDF document and/or a text prompt requesting a summary of an uploaded video file. A query may be simple, directed to a single modality-specific model, such as audio analysis, video analysis, image analysis, image generation, document processing, or text processing. For example, an image generation task may be initiated by a standalone text prompt, such as “Generate a photorealistic image of a mountain at sunset,” without any accompanying attachments. Alternatively, queries can be complex, necessitating orchestration across multiple models and modalities to fulfill the requested task comprehensively. For example, a multi-part query may request object detection from an image and synthesis of related textual content based on prior document context, requiring coordinated routing across vision and text models.

System 100 may preprocess the one or more queries to support downstream routing and/or model selection. For example, system 100 may extract metadata, resize and/or vectorize image files, transcribe words in audio files, and/or parse text in document files into structured segments. In some implementations, modality-specific transformations may include, for example, converting raw input data into a normalized form suitable for classification and/or embedding raw input data into a vector representation to capture semantic and/or structural features. For image-based input data, preprocessing may include converting files to a standard resolution and/or format (e.g., PNG and/or JPEG), converting to greyscale, and/or generating a vector embedding using a vision encoder such as CLIP. For audio-based input data, preprocessing may include applying noise reduction and/or generating transcripts using speech recognition models such as Whisper. For video-based input data, preprocessing may include sampling and/or extracting representative image frames. For document-based input data, preprocessing may include detecting layout elements (e.g., headers, tables, and/or sections), extracting text using optical character recognition from image-based documents, and/or segmenting content based on document context to create groupings for classification and/or routing. In some implementations, metadata such as file type, timestamp, language, encoding format, and/or estimated input length may also be extracted and/or used during subsequent routing steps. Additionally or alternatively, the above-described preprocessing steps may be handled by one or more general-purpose large language models such as ChatGPT, Gemini, and/or Claude.

Based on the received one or more queries, process 130 may continue at step 136 at which system 100 may determine one or more classifications corresponding to the one or more queries. For example, system 100 may perform a preliminary classification to determine whether the one or more queries include a text-based input and/or a non-text input, such as an audio-based input, an image-based input, an image generation-based input, a video-based input, and/or a document-based input. In some implementations, this classification may be performed using keyword detection, file type recognition, basic metadata analysis, and/or advanced classifiers (e.g., trained vision models or speech detectors). In some implementations, this classification may take the form of assigning a modality flag to the one or more queries based on the detected content. Such a modality flag may be used by system 100 to direct the one or more queries to an appropriate text-processing machine learning module and/or a modality-specific machine learning module. For example, one or more flags including a text flag, an audio flag, a video flag, a vision flag, and/or a document flag may be added to the one or more queries to enable routing to the correct machine learning module. In some implementations, this initial modality determination may be based on straightforward criteria such as keyword detection, file type recognition, and/or metadata analysis.

For example, modality-specific machine learning modules may include modules for handling text-based queries (e.g., summarization, translation, and/or classification using models such as GPT-40, Claude, Gemini, LLaMA, and/or Mixtral), image-based queries (e.g., object detection and/or captioning using CLIP, YOLO, and/or ResNet), image generation-based queries (e.g. using DALL-E 3), document-based queries (e.g., text extraction and/or document classification using LLaMA, Mixtral, GPT-40, and/or Claude), audio-based queries (e.g., transcription and/or speaker identification using Whisper, Wav2Vec, DeepSpeech, and/or Jasper), and/or video-based queries (e.g., video summarization and/or object tracking using VideoBERT, GPT-4 Vision, LLAVA, and/or VideoLLaMA). A follow-up-specific multi-model Mixture-of-Expert module may also be employed to consolidate outputs from multiple specialized models and/or switch between them based on task complexity.

For example, if a user has access to traditional, specialized models—such as an object detection model like YOLO—an exemplary system may seamlessly integrate this existing capability with an available small language model (SLM) to effectively address user queries. Specifically, YOLO may detect objects within an image, and the SLM may interpret these detections into coherent textual responses tailored to the user's query. This may ensure optimal utilization of available resources without involving additional, costly model integrations.

In some implementations, if the one or more queries include both a text-based input and one or more attachments, such as an image, audio file, video clip, and/or document, system 100 may apply a routing strategy based on the type and number of attachments. For example, when the one or more queries include a text-based input along with a single attachment, the system may identify the attachment type (e.g., image, video, audio, and/or document) using one or more of the aforementioned techniques. The one or more queries may then be routed to one or more corresponding modality-specific modules, where both the text and the attached content may be analyzed. For example, a query that includes a text prompt and a single image file may be routed to an image-processing machine learning model and/or a multimodal machine learning model that uses both the text and image inputs to guide interpretation and/or to generate a response.

For example, if the one or more queries include multiple attachments (e.g., multiple uploaded files and/or links), system 100 may classify the received inputs as a complex multimodal query. In this example, the query may be flagged for coordinated processing within a multi-agent execution framework that may route individual inputs to be processed in parallel and/or sequentially depending on interdependencies between the inputs. For example, if a user uploads an image and a separate PDF file with no interdependency, system 100 may route each to separate specialized task-and/or modality-specific machine learning models, for example an image-captioning machine learning model and a document-summarization machine learning model respectively. These two machine learning models may then process each input individually in parallel, thereby optimizing response time. In contrast, if a query includes a video file along with a text prompt such as “summarize the conversation in the video,” system 100 may first transcribe the video using a speech-to-text machine learning model and then pass the transcription to a language model for summarization, thereby executing processing of the inputs sequentially based on their dependency.

In some implementations, queries such as “summarize the conversation in the video” may be routed directly to specialized video-processing models, such as VideoLLaMA, which may handle the task end-to-end. However, models like VideoLLaMA may be computationally intensive, requiring substantial resources and processing power, which may make local deployment challenging in resource-constrained scenarios.

To manage costs and computational limitations, the framework may be designed with flexibility to adapt to user-specific resources and constraints. For instance, if high-resource models such as VideoLLaMA may not be viable due to user limitations, the framework may instead leverage simpler, lower-cost workflows. These workflows may include first transcribing the audio content using lightweight speech-to-text models (e.g., Whisper or Wav2Vec), followed by summarization using an accessible language model. This alternative may be especially effective when the query emphasizes audio content rather than detailed visual analysis.

Accordingly, the choice between using an advanced model such as VideoLLaMA or employing a sequential processing strategy using simpler models may depend on user preferences, resource availability, and specific task requirements. The core strength of the framework may lie in this adaptability—once configured, the system may orchestrate whichever resources are already available to the user.

Use of such a routing method by system 100 may ensure that modality-specific modules can process both standalone attachments and multimodal text-plus-attachment inputs without being restricted to handling only a single type of input in isolation. In contrast, if the one or more queries are classified with only a text flag, the input may be routed to a dedicated text-processing machine learning module along a processing path distinct from that used for non-text inputs described above.

Process 130 may proceed from step 136 to step 140 at which system 100 may determine the one or more classifications determined at step 136 include a non-text classification, indicating that the one or more queries include non-text content. For example, the one or more queries may include at least one of an audio-based input, an image-based input, an image generation-based input, a video-based input, and/or a document-based input.

At step 142, system 100 may route the one or more queries, optionally based in part on the received cost preference selection and/or on computational constraints, to at least one machine learning model, including but not limited to: audio-processing machine learning models (e.g., Whisper and/or Wav2Vec), image-processing machine learning models (e.g., YOLO and/or CLIP), image-generation machine learning models (e.g., DALL-E 3), video-processing machine learning models (e.g., VideoLLaMA), document-processing machine learning models (e.g., LLaMA-based Q&A systems), and/or multimodal machine learning models (e.g., Mixtral MoE). For example, system 100 may route the one or more queries the most appropriate single machine learning model or subset of machine learning models. For example, system 100 may select the most appropriate single machine learning model or subset of machine learning models based on the modality, for example matching an audio-based input with an audio-processing machine learning model such as Whisper.

Additionally or alternatively, system 100 may select the most appropriate single machine learning model or subset of machine learning models based on one or more domains and/or one or more tasks associated with the one or more queries. For example, selection of the most appropriate single machine learning model or subset of machine learning models may account for tasks indicated in the one or more queries (e.g., captioning, object detection, and/or transcription), computational constraints, and/or prior user feedback. Such selection may additionally or alternatively be informed by the domain context of the query, including but not limited to legal domains (e.g., contract summarization and/or clause extraction), medical domains (e.g., report interpretation and/or diagnostic reasoning), financial domains (e.g., earnings report analysis and/or transaction classification), and/or coding domains (e.g., source code generation and/or API documentation parsing). If system 100 detects that the one or more queries are part of a follow-up interaction, the routing module may also retrieve prior context and/or decide whether to continue processing within the same module or escalate to an expert model (e.g., a multi-model Mixture-of-Experts system) capable of reasoning across different modalities as described in greater detail below.

When escalation may occur for handling complex multimodal queries, the system may route the task to a powerful general-purpose language model such as GPT-40 or, for visual reasoning, GPT-4 Vision. In some implementations, a Mixture-of-Experts (MoE) model may be used within the framework as a specialized textual language model rather than a natively multimodal model. The MoE model may take as input the outputs generated by multiple specialized models (e.g., image analysis results, audio transcriptions, or document summaries) and may integrate or synthesize these separate outputs into a coherent, unified textual response that directly addresses the original user query.

The MoE aggregation mechanism may operate by assigning adaptive weights to the outputs of various modality-specific models, based explicitly on how well those outputs align with the user's central query or main intent. For instance, a user query may involve analyzing multiple modalities—such as extracting key facts from a document and identifying related content in an image—while ultimately requesting a textual summary or direct textual insight. The MoE model may intelligently aggregate the modality-specific outputs by prioritizing and weighting them based on their relevance to the user's core question, ensuring that the final response accurately and effectively satisfies the intended objective.

A Mixture-of-Experts (MoE) model may refer to a machine learning architecture that combines multiple specialized “expert” models or components to address complex tasks more effectively. Each expert within the MoE model may focus on a particular input type or sub-task. A gating or routing mechanism may dynamically determine how inputs are distributed among these experts and/or how their outputs are aggregated based on contextual signals, task relevance, or the nature of the received query.

In some implementations, system 100 may employ a multi-agent framework to coordinate the routing of text and/or non-text inputs across specialized machine learning models. For example, upon receiving a complex query containing an image, the system may invoke a routing agent configured to decompose the query into modality-specific subtasks and dispatch the image portion to an image analysis module (e.g., CLIP and/or YOLO). These models may be specifically used for object detection tasks within image inputs; otherwise, the system may route image-based queries to a general-purpose vision model such as GPT-40 or to an image generation model such as DALL-E 3, depending on the nature of the task. The multi-agent framework may determine whether each subtask should be executed in parallel and/or in sequence based on interdependencies, and may further assign subtasks to execution modules tailored for audio transcription, document summarization, and/or video frame extraction. For example, if a user submits an image of a chart along with the prompt “Explain this in plain language,” the image may be processed by an image-processing machine learning model to extract key elements, and the resulting output may be routed to a text-processing machine learning model to generate a simplified natural language explanation. Once processed, a multi-model Mixture-of-Experts system may be used to aggregate results from each modality-specific and/or specialized machine learning model to produce a unified final output response.

In some implementations, if the received user query may be directly addressed by an advanced image-processing model capable of vision-language reasoning, such as GPT-40 Vision, the system may process the query end-to-end without further routing or aggregation. For example, in response to a query such as “Explain this in plain language,” the image-processing model may independently extract visual elements from the chart and provide a simplified textual explanation.

However, if the user query may involve multiple distinct steps—such as extracting numerical data from a pie chart image and subsequently analyzing or cross-referencing the extracted data with information from a separate document—the system may invoke a sequential multi-step processing strategy coordinated by the multi-agent framework. In such an example, the framework may first invoke an image-processing model, such as GPT-40 Vision or another specialized visual analysis model, to extract data from the image. The extracted numerical data may then be passed to a document-analysis model or text-processing model to perform additional interpretation, analysis, or contextual linking based on the separate document provided by the user.

After the completion of these steps, the outputs from the different processing modules may be combined by a Mixture-of-Experts (MoE) system. The MoE system may aggregate these modality-specific outputs, intelligently assigning weights based on relevance and/or alignment with the user's ultimate query intent. The final result may be a cohesive, unified textual response that addresses the user's original multi-step and/or multimodal request.

In some implementations, system 100 may determine whether a complexity associated with the one or more queries meets a predefined complexity threshold based on factors such as input length and/or multimodal content. This predefined complexity threshold may be informed by system context, historical feedback, and/or performance balancing goals. Complexity may be estimated using heuristics and/or predictive models, such as a win prediction model that assesses the likelihood of improved performance from a higher-tier machine learning model. For example, a simple image with a caption request may fall below the threshold, while a complex video segment requiring object tracking and/or scene interpretation may exceed it. If the input is determined to meet or exceed the complexity threshold, system 100 may route the query to one or more high-performance models, such as GPT-40, Gemini, and/or Claude. In some cases, a multi-model Mixture-of-Experts system may be used to aggregate outputs from multiple specialized models, thereby improving response output quality for complex multimodal inputs.

In some implementations, non-text queries may be directly routed to a pre-selected machine learning model based on user-defined cost preferences for each modality. For instance, a video input query may directly utilize a specified video-processing model, such as VideoLLaMA or GPT-4 Vision, without evaluating query complexity. Complexity-based thresholding may be employed within the text-processing module. Specifically, a model such as RouteLLM, which may be integrated into the text-processing pipeline, may dynamically assess the complexity of a query based on its trained understanding of textual input structure, language nuance, and query intricacy.

Alternatively or additionally, process 130 may proceed from step 136 to step 150 at which system 100 may determine that the one or more classifications determined at step 136 include a text classification, indicating that at least one of the one or more queries comprises a text-based input. For example, system 100 may determine that the one or more classifications determined at step 136 include only a text classification. Examples of text-based inputs may include a typed question submitted through a web interface, a plain text email body, a PDF document containing written content, a product review, a chat log, and/or a portion of source code.

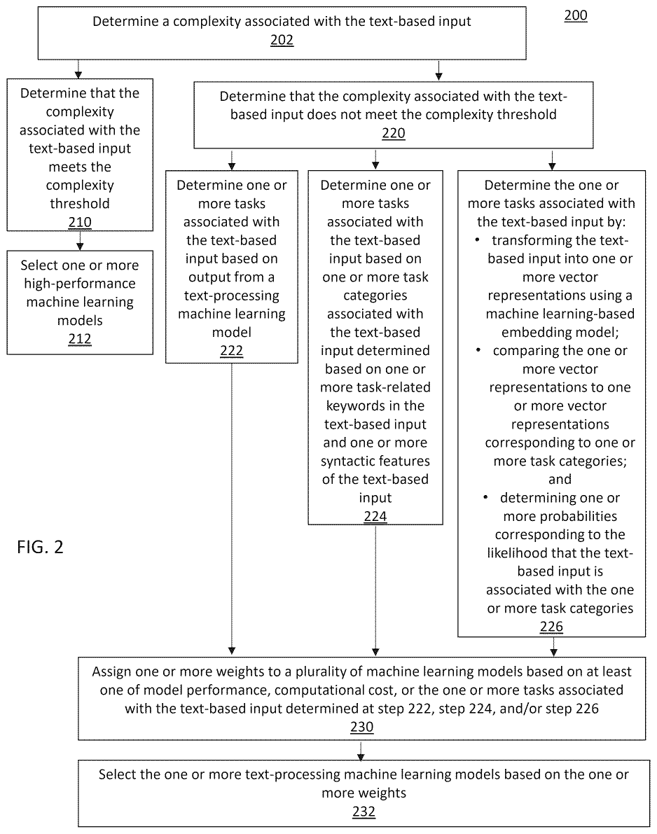

Step 150 may additionally include determining a complexity associated with the text-based input and/or determining one or more tasks associated with the text-based input as described in further detail in the context of FIG. 2. For example, system 100 may classify the one or more queries using keyword-based classifiers, syntactic/structural analysis, and/or semantic embedding comparison. In some implementations, a keyword module may scan for task indicators like “summarize,” “generate code,” and/or “translate.” In some implementations, a query structure classifier may identify patterns like code syntax and/or nested logic. In some implementations, a semantic classifier may transform the one or more queries into vector embeddings to match them against task clusters using similarity search. Such a multi-pronged classification strategy may allow system 100 to determine one or more tasks associated with the text-based input for use in selecting the most appropriate machine learning model or models for processing the one or more queries.

Additionally, the semantic classification module may significantly enhance the configurability and flexibility of the framework. The ability to transform queries into vector embeddings and match them against specific task clusters may enable seamless integration of any specialized or fine-tuned machine learning model. For example, in scenarios involving legal or tax-domain tasks, where accuracy may depend heavily on domain-specific training, companies may develop models finely tuned on proprietary or highly specialized datasets. The described classification strategy may facilitate straightforward inclusion of such tailored models into the system, effectively enabling a plug-and-play functionality.

At step 152, system 100 may route the one or more queries, again optionally based in part on the received cost preference and/or on computational constraints, to one or more text-processing machine learning models. In this way, routing the one or more queries to one or more text processing machine learning models includes selecting one of the text-processing machine learning models based on a complexity associated with the text-based input, one or more tasks associated with the text-based input, or both.

For example, if system 100 determines that the one or more queries are simple and/or low-complexity, it may route the one or more queries to a lightweight open-source and/or instruction-tuned small language model (e.g., Mistral, LLaMa, and/or Falcon). For more complex queries corresponding to, for example, document summarization with embedded questions and/or creative generation tasks, system 100 may route the one or more queries to one or more high-performance LLMs (e.g., GPT-40, Gemini, and/or Claude). In some implementations, if the one or more tasks associated with the text-based input correspond to a particular domain (e.g., legal and/or financial documents), system 100 may invoke a specialized machine learning model optimized for that particular domain. Additionally or alternatively, system 100 may break the one or more tasks associated with the text-based input into subtasks (e.g., summarization followed by generation) and execute the subtasks in parallel and/or in sequence, based on the dependency structure of the subtasks as mentioned above.

Regardless of whether system 100 determined, at step 140 or step 150, the one or more classifications include a non-text or a text classification, both step 142 and step 152 of process 130 lead to step 160. At step 160, system 100 may generate an output response based on processing performed by one or more machine learning models to which the one or more queries were routed. This output response may be the result of a single machine learning model's inference or a composite output from multiple models coordinated by a model aggregation system (e.g., a multi-model Mixture-of-Experts system). In the case of decomposed queries, subtasks may be executed in parallel (for independent subtasks) and/or in sequence (for dependent subtasks), and the outputs of various subtask executions may be merged into a final output response. The format of the output response may vary depending on the modality and/or task corresponding to the one or more queries including, for example, natural language answers, structured data, extracted visual and/or audio features, and/or multimodal explanations.

In some implementations, the final output response may depend on the nature and complexity of the user's query. For simple or single-modality queries, the response may result directly from a single machine learning model's inference. For example, an image-captioning model may generate a textual caption in response to an image input. However, for complex queries involving multiple modalities and/or multiple specialized models—such as queries requiring simultaneous analysis of image data, audio content, and document text—each machine learning model may independently produce an output corresponding to its respective modality. These individual outputs may then be aggregated and passed to a Mixture-of-Experts (MoE) text-processing model, such as Mixtral. The MoE model may synthesize these modality-specific outputs into a cohesive, curated textual response tailored to address the user's original multi-faceted query.

In some implementations, the final output response may depend on the nature and complexity of the user's query. For simple or single-modality queries, the response may result directly from a single machine learning model's inference. For example, an image-captioning model may generate a textual caption in response to an image input. However, for complex queries involving multiple modalities and/or multiple specialized models—such as queries requiring simultaneous analysis of image data, audio content, and document text—each machine learning model may independently produce an output corresponding to its respective modality. These individual outputs may then be aggregated and passed to a Mixture-of-Experts (MoE) text-processing model, such as Mixtral. The MoE model may synthesize these modality-specific outputs into a cohesive, curated textual response tailored to address the user's original multi-faceted query.

In some implementations, system 100 may include one or more fallback mechanisms to improve query handling in cases in which the one or more confidence scores associated with the routing of the one or more queries do not meet a predefined confidence threshold. The one or more confidence scores may be derived from calibrated model outputs, historical model performance, and/or metrics indicating alignment between an input and the determined one or more tasks. In accordance with determining that the one or more confidence scores do not meet the confidence threshold, system 100 may reroute the one or more queries to one or more alternative machine learning models selected to provide higher performance relative to the originally routed one or more machine learning models. For example, if a low-confidence score is associated with a response generated by an open-source summarization model, the query may be escalated to a high-performance proprietary LLM optimized for long-context understanding, such as GPT-40, Gemini, and/or Claude. In some implementations, queries that fail to meet a confidence threshold may be escalated to a human-in-the-loop system for query and/or input review and/or revision. In some implementations, if system 100 fails to generate a satisfactory output response one or more times, for example if system 100 fails to generate a satisfactory output response three times, system 100 may escalate to a high-performance proprietary LLM and/or flag for human-in-the-loop review.

In some implementations, system 100 may additionally or alternatively incorporate a simplified fallback strategy based on explicit user feedback collected following each query response. If a user may indicate dissatisfaction with a response, such as through a low feedback rating associated with an output generated by a lower-cost or open-source model, system 100 may reroute the one or more queries to a higher-performance, larger-scale model. For example, the query may be escalated to a proprietary language model such as GPT-40 or another comparable high-performance model to improve output quality.

Additionally or alternatively, system 100 may support fallback routing based on user-initiated feedback. For example, system 100 may receive feedback indicating that the output response does not meet a satisfaction criterion, either through explicit correction, selection of a feedback interface option, and/or based on a natural language input such as “this isn't what I asked for.” In accordance with receiving such feedback, system 100 may reroute the one or more queries to one or more alternative machine learning models to generate a revised output response, wherein the one or more alternative machine learning models may be selected to provide higher performance relative to the originally routed one or more machine learning models. For example, if a user submits a prompt requesting a creative rewrite and finds the initial output too rigid, system 100 may redirect the one or more queries to a higher-performance and/or more expressive LLM trained for creative content generation. In some implementations, user feedback may also be logged and/or labeled with the corresponding query classification and/or machine learning model response time to improve routing performance in similar scenarios.

FIG. 2 depicts an exemplary process 200 for routing the one or more queries to one or more text-processing machine learning models as described above in the context of step 152 of FIG. 1B. As with step 152, process 200 may follow a determination that the one or more classifications of the one or more queries include a text classification, indicating that at least one of the one or more queries comprises a text-based input. For example, system 100 may determine that the one or more classifications include only a text classification. As depicted in FIG. 2, exemplary process 200 may include selecting one or more appropriate text-processing machine learning models to process the one or more queries, based on an assessment of query complexity, task category, and/or model-specific criteria such as performance and/or computational cost. In this way, process 200 may support intelligent distribution of workload across open-source and proprietary machine learning models, including small language models, traditional machine learning models, and/or high-performance LLMs.

At step 202, system 100 may determine a complexity associated with a text-based input corresponding to the one or more queries and at step 210 may determine that the complexity meets a predefined complexity threshold. This predefined complexity threshold may be determined based on the operational context of system 100, historical user feedback, and/or workload balancing preferences. For example, the predefined complexity threshold may be set such that only highly complex queries, for example less than 3% of queries received, meet the predefined complexity threshold.

Complexity of the text-based input may be determined based on the one or more queries and/or on one or more text-based files attached to the one or more queries. For example, complexity of the text-based input may be determined based on one or more of: input length, linguistic structure, number of syntactic clauses, presence of embedded code blocks, document structure, and/or presence of semantic ambiguity. Additionally or alternatively, the complexity determination may be based on a win prediction model that may predict the probability of a particular machine learning model outperforming another machine learning model, based on user preference data and/or machine learning model benchmark results. For example, the win prediction model may predict the probability of a strong machine learning model outperforming a weak machine learning model.

In some implementations, complexity handling may be performed by a dedicated model such as RouteLLM, which may serve as a task-routing decision model. For example, the system may evaluate the probability that a high-performance machine learning model (a “strong” model) would generate a better response than a lower-cost, resource-efficient model (a “weak” model). This probability may serve as a win prediction metric used to guide model selection. If the predicted likelihood of improved performance by the strong model exceeds a predefined threshold (e.g., 50%), the system may route the query to the strong model. Otherwise, the query may be routed to the weak model. The threshold used to determine model selection may be denoted as α and may be set based on cost-performance tradeoffs. A lower threshold may prioritize output quality by routing more queries to high-performance models, while a higher threshold may prioritize cost-efficiency by utilizing lower-cost models more frequently.

For example, a short query like “summarize this paragraph” may be considered low complexity, whereas a prompt such as “extract the financial implications of this legal document and compare them to tax regulations” may exceed the predefined complexity threshold due to its compound request and request for specialized knowledge. For example, a one-page document containing a plain-language summary of a news article may fall below the predefined complexity threshold, while a 20-page technical report containing embedded tables, citations, and/or legal disclaimers may be classified as high complexity due to the informational density and specialized language associated with the input.

Following determination, at step 210, that the complexity associated with the text-based input meets the predefined complexity threshold, system 100 may proceed to step 212, at which one or more high-performance machine learning models may be selected. These models may include proprietary LLMs (e.g., GPT-40, Gemini, and/or Claude) that may exhibit robust reasoning capabilities, support for extended input sequences, and/or adaptability to specialized subject matter. The selection of the one or more high-performance machine learning models may be based on available compute capacity, the received cost preference selection, and/or model specialization. In some implementations, high-complexity queries may also trigger model aggregation via a multi-model Mixture-of-Experts system as described above, enabling the use of multiple expert models in parallel, with outputs weighted and combined for final response generation.

If instead, at step 220, system 100 determines that the complexity associated with the text-based input does not meet the complexity threshold, system 100 may initiate a task classification process. Said task classification process may involve multiple layers and/or modules as described below. For example, at step 222, one or more tasks associated with the text-based input may be determined based on output from a text-processing machine learning model. For example, one or more inferences as to the task category may be generated using a lightweight machine learning model that produces a high-level task associated with the task-based input. For example, system 100 may generate, using a lightweight machine learning model, high-level tasks such as “rephrase,” “summarize,” “translate,” and/or “analyze tone.” The lightweight machine learning model may be a small instruction-tuned LLM and/or a small language model fine-tuned for rapid task identification (e.g., Microsoft Phi-3-mini-128k-instruct). In some implementations, the machine learning model may assign one or more scores and/or probabilities representing the alignment between the determined one or more tasks and the text-based input. The one or more tasks output by the machine learning model may be stored and/or used downstream for scoring and/or selecting between candidate text-processing machine learning models.

In parallel to processing of step 222 and/or sequentially before and/or after processing of step 222, system 100 may, at step 224, determine one or more tasks associated with the text-based input based on one or more task categories associated with the text-based input. These one or more task categories may be determined based on one or more task-related keywords in the text-based input and/or on one or more syntactic features of the text-based input, for example using a keyword classifier and/or a query structure classifier. For example, the one or more task categories may include at least one of summarization, translation, code generation, or mathematical reasoning. The keyword classifier may identify task-specific phrases, keywords, and/or entities within the text-based input to determine at least one intent associated with the text-based input. It may scan for predefined keywords (e.g., “Python script,” “summarize,” “rewrite,” and/or “generate code”), and optionally assign scores and/or probabilities to the determined one or more tasks representing the fit between a particular task and the text-based input. For example, such probabilities and/or score may be used for determination, at a later point in process 200, of the most relevant machine learning model and/or query-processing pipeline.

Such detected keywords may be combined with detections of syntactic patterns such as quoted instructions, hierarchical expressions and/or sequences, lists, and/or language-specific symbols, and used to better inform selection of the one or more task categories. The query structure classifier may analyze the syntactic and/or structural components of the one or more queries to determine at least one intent associated with the text-based input. For example, determination of these syntactic and/or structural components may be used when keyword detection alone is insufficient. For example, the query structure classifier may leverage machine-learning-enhanced regular expression detection to classify the one or more queries that may contain, for example, hierarchical expressions and/or sequences, structures governing execution flow, and/or domain-specific syntax (e.g., syntax associated with Python, JavaScript, SQL, and/or HTML). Similar to the keyword classifier, the query structure classifier may assign scores and/or probabilities to the determined one or more tasks representing the fit between a particular task and the text-based input. For example, a text-based input that contains indented blocks with function definition keywords may be labeled with one or more task categories associated with code generation. In some implementations, such a determination may enable routing to a machine learning model for code generation at a later step of process 200.

Determination of task-based categories at step 224 may serve be used as an alternative to and/or in addition to (e.g., as a refinement to) the output of the machine learning model at step 222 as discussed in further detail below. For example, probabilities and/or scores generated by the machine learning model at step 222 and/or step 224, corresponding to the fit between tasks determined by the machine learning model and by the keyword classifier and/or query structure classifier, may be combined to refine the determined one or more tasks associated with the text-based input.

In parallel to processing of steps 222 and/or step 224 and/or sequentially before and/or after processing of step 222 and/or step 224, system 100 may, at step 226, determine the one or more tasks associated with the text-based input by executing all or part of a more advanced semantic classification process. For example, this semantic classification process may include one or more of the following steps: transforming the text-based input into one or more vector representations using a machine learning-based embedding model, comparing the one or more vector representations to one or more vector representations corresponding to one or more task categories, and/or determining one or more probabilities corresponding to the likelihood that the text-based input is associated with the one or more task categories. For example, the one or more task categories may include at least one of summarization, translation, code generation, or mathematical reasoning.

For example, the text-based input may be converted into one or more vector embeddings using a transformer-based embedding model. These one or more vector embeddings may then be compared to pre-clustered vectors representing one or more tasks, using techniques such as nearest neighbor search and/or FAISS similarity indexing. Each task of the one or more tasks may correspond to a known task category and/or processing path (e.g., “summarization,” “coding,” “analytical tasks,” “Q&A,” “document understanding,” “tone shift,” and/or “instruction following”), with system 100 assigning a probability distribution over these categories. For example, if a vector embedding corresponding to the text-based input is located close in vector space to embeddings associated with “document summarization” and/or “paraphrasing” task clusters, system 100 may select machine learning models optimized for document summarization and/or paraphrasing depending on additional constraints associated with the text-based input.

System 100 may additionally determine scores indicating degree of confidence that the determined one or more tasks correspond to the text-based input. Calibration methods such as Platt Scaling and/or Isotonic Regression may be used to normalize and/or improve the accuracy and/or reliability of the confidence scores associated with the one or more tasks. For example, these calibration methods may be used in combination with a classifier such as the Route0x classifier. If a resulting calibrated confidence score remains below a predefined confidence threshold, system 100 may invoke one or more anomaly detection techniques including, for example, Local Outlier Factor and/or Isolation Forest, to determine whether the text-based input of the one or more queries is out-of-domain and/or out-of-scope. Such a determination may indicate that the text-based input is outside the expected and/or supported range of inputs that system 100 is configured to handle. In one or both cases, the text-based input may be routed to a secondary and/or fallback classification machine learning model and/or escalated to a general-purpose machine learning model with broader task classification ability.

In some implementations, the semantic classification process of step 226 may be handled by a routing engine that may serve as a fallback mechanism engaged when other task classification attempts, such as those based on machine learning model output and/or keyword detection and/or structural pattern recognition at steps 222 and/or 224, fail to produce one or more high-confidence tasks associated with the task-based input and/or produce determinations of tasks that are inconsistent with one another. For example, the machine learning model output of step 222 may determine the one or more tasks include “summarize” whereas keyword detection and/or structural pattern recognition of step 224 may determine the one or more tasks include “generate follow-up material.” That is, system 100 may attempt to determine the one or more tasks associated with the text-based input by first using the machine learning model approach of step 222 and/or the keyword detection and/or structural pattern recognition approach of step 224, for example by attempting step 222 before attempting step 224. If steps 222 and/or 224 fail to produce one or more high-confidence tasks associated with the task-based input and/or produce inconsistent tasks, system 100 may then attempt to determine the one or more tasks associated with the text-based input by using the semantic classification process and routing engine approach of step 226.

Thus, the routing engine of step 226 may act as a centralized decision module that selects appropriate processing paths when keyword-and/or structure-based classifiers do not yield one or more high-confidence tasks associated with the task-based input. In addition to semantic similarity and/or confidence analysis, the routing engine may support integration with custom task handlers and/or domain-specific agents. For example, if a user submits a legal document with minimal accompanying instruction, the routing engine may assign the task to a legal document analysis agent based on semantic proximity to known legal inputs. In some implementations, a vague query such as “improve this” attached to a technical report may be routed to a writing enhancement model rather than a summarization model. Similarly, if a query includes domain-specific code snippets in an unfamiliar format, the routing engine may escalate the text-based input to a general-purpose LLM for broader interpretation.

Based on the results of the task classification process represented by steps 222, 224, and/or 226, system 100 may, at step 230, assign one or more weights to a plurality of machine learning models based on at least one of model performance, computational cost, and/or the one or more tasks associated with the text-based input. Assignment of the one or more weights to the plurality of machine learning models may be based individually on the one or more tasks and/or one or more domains determined to be associated with the text-based input at each of machine learning model processing step 222, keyword and/or query structure classification step 224, and/or routing engine-based semantic classification process step 226. For example, assignment of the one or more weights may be based on only one of the above-described processes, on only two of the above-described processes, and/or on all three of the above-described processes.

Similar to the determination of one or more tasks, system 100 may attempt to assign one or more weights to the plurality of machine learning models by first using the one or more tasks determined by the machine learning model approach of step 222 and/or the one or more tasks determined by the keyword detection and/or structural pattern recognition approach of step 224, for example by using one or more tasks determined by step 222 before the one or more tasks determined by step 224. If system 100 is unable to assign one or more weights or if the one or more weights assigned to the plurality of machine learning models based on one or more tasks determined by steps 222 and/or 224 fail to converge (e.g., are significantly different from one another) and/or fail indicate a single appropriate machine learning model or subset of machine learning models, system 100 may then attempt to assign one or more weights to the plurality of machine learning models based on the one or more tasks determined by the semantic classification process and routing engine approach of step 226.

The one or more weights assigned to the plurality of machine learning models may represent system 100's confidence in the selection of a particular machine learning model for the particular text-based input of the one or more queries. For example, these one or more weights may represent the degree of alignment between a particular machine learning model's processing strengths and the text-based input, with higher weights optionally representing higher alignment. Each machine learning model may be scored based on multiple factors including, for example, past performance on similar tasks, computational cost (e.g., token-based pricing and/or latency), resource availability (e.g., current GPU load), and/or model alignment with the determined one or more tasks. For example, certain machine learning models may be assigned a higher weight for tasks such as “rewrite in simpler language,” whereas other machine learning model may be assigned a higher weight for tasks involving Q&A over structured and/or unstructured documents. In some implementations, user preferences and/or organizational policies (e.g., “use open-source models where possible”) may additionally or alternatively influence weights assigned by system 100. In some implementations, user preferences or organizational policies—such as prioritizing open-source models—may be explicitly provided as separate configuration inputs by the user, distinct from the actual query or follow-up query prompts. These preferences may serve as additional parameters guiding model selection and resource allocation, and may influence the weight assignment process by modifying or constraining the eligible pool of machine learning models.

In some implementations, system 100 may further refine the one or more weights assigned to the plurality of machine learning models using kernel density estimation to convert the discrete and potentially noisy weight assignments into a continuous probability distribution. For a particular machine learning model, this smoothing technique may be applied to weights generated based on outputs from one or more of the above-described processing steps, including machine learning model processing step 222, keyword and/or query structure classification step 224, and/or routing engine-based semantic classification process step 226. The resulting continuous probability distribution may improve the robustness of routing decisions by dampening outlier effects and/or emphasizing consensus across the different classification processes.

In some implementations, system 100 may utilize kernel density estimation (KDE) as a statistical technique to further enhance the robustness of routing decisions. KDE may be a non-parametric method for estimating a probability density function by placing a smooth kernel (e.g., Gaussian) on each data point and summing them to produce a continuous distribution. By applying KDE to outputs from the various classification processes, system 100 may obtain a smoothed probability distribution over potential task classifications. This smoothing may dampen the impact of outliers and emphasize agreement among the classifiers, resulting in more stable and reliable routing decisions. For example, in a scenario where a document upload could pertain to either legal or financial domains, different classifiers may assign varying probabilities to each category. KDE may aggregate these probabilities into a continuous distribution that reveals the most probable classification. The system may then route the query to the most appropriate domain-specific machine learning model, such as a legal-specific or financial-specific model. In some implementations, KDE may serve as a core component within the system's decision-making pipeline. The output of KDE may be used by the routing module to guide final model selection, ensuring the system can handle ambiguous or complex inputs with greater confidence and accuracy.

For example, if one candidate machine learning model is assigned marginally different weights based on two or more of the above-described classification processes, system 100 may use kernel density estimation to reconcile these weights into a more stable selection probability distribution. Thus, consensus between different classification processes may be represented by tightly clustered support, for example a probability distribution in the form of bell curve with a high peak at or near a particular weight and/or probability representing the degree of alignment between the particular machine learning model and the text-based input. Alternatively, inconsistencies between different classification processes may result in a probability distribution in the form of bell curve with wider and/or flatter peak representing a spread of weights and/or probabilities.

Thus, kernel density estimation and continuous probability distribution generation may enable system 100 to more easily understand the confidence landscape and/or degree of consensus between different classification processes. In cases in which kernel density estimation reveals a significant divergence or ambiguity in weights assigned to a particular machine learning model, system 100 may trigger a reprocessing of the text-based input. This reprocessing may entail redetermining the one or more tasks associated with the text-based input using the advanced semantic classification process and/or routing engine-based approach described above in the context of step 226. The reprocessing may further entail reassigning one or more weights to the plurality of machine learning models based on those redetermined one or more tasks. Kernel density estimation may then be re-applied to generate an updated continuous probability distribution.

At step 232, system 100 may select one or more text-processing machine learning models based on the assigned one or more weights. In some implementations, if only one machine learning model is associated with a high weight (e.g., good alignment between the model's processing strengths and the text-based input), the one or more queries may be routed to that machine learning model for processing. For example, the one or more queries may be routed to the machine learning model with the highest weight and/or alignment between the text-based input and the particular machine learning model. In other implementations, multiple machine learning models may be invoked in parallel, and their outputs may be compared and/or aggregated. In some implementations, the selected machine learning model may produce an intermediate output which may then be passed to a secondary machine learning model for post-processing, involving selection at step 232 of two machine learning models. For example, one or more queries may involve generating a summary using a first machine learning model, and reformatting the summary into bullet points using a second machine learning model. Once selected, the one or more text-processing machine learning models may be used to generate an output response as described in FIG. 1B in the context of step 160.

In some implementations, a first machine learning model may generate a textual summary from a lengthy financial document. Subsequently, a second, specialized analytical or mathematical evaluation model may perform follow-up operations such as verifying key financial metrics, calculating statistical values, or testing a specific business hypothesis (e.g., “Has revenue growth exceeded projected rates over the past quarters?”). This two-step processing approach—first summarizing complex information, then performing targeted analytical or mathematical evaluation—may enable system 100 to support multi-step reasoning and precise analytical workflows within the same query handling session.

In some implementations, system 100 may route queries directly to the single machine learning model exhibiting the highest alignment or assigned weight with respect to the user's input. However, if the alignment or weights associated with multiple candidate models do not clearly converge—indicating a more complex scenario in which multiple models may be simultaneously relevant—system 100 may classify the query as a complex, multimodal scenario. In such cases, the query may be escalated and managed through a complex query handling multi-agent framework. This multi-agent framework may decompose the complex query into smaller subtasks, route each subtask to one or more specialized machine learning models most suitable for the respective task, and subsequently aggregate the outputs from these models into a coherent and unified final response.

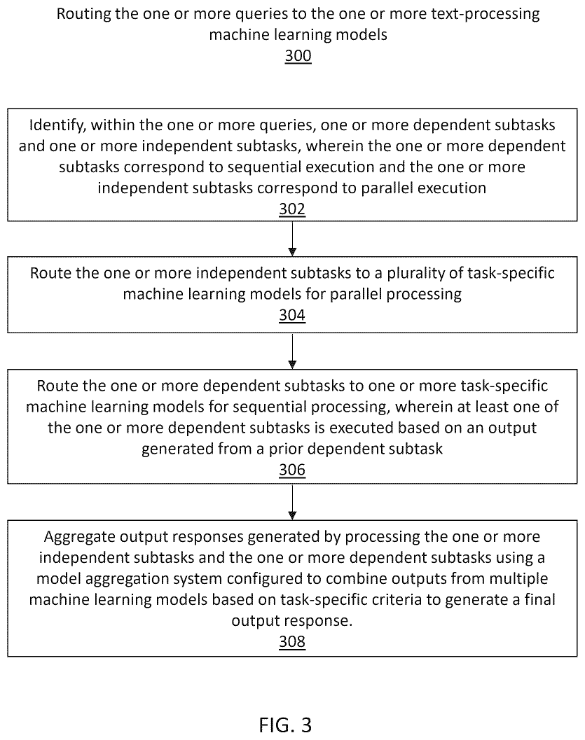

FIG. 3 depicts an exemplary process 300 for routing the one or more queries to one or more text-processing machine learning models by decomposing the one or more queries into one or more subtasks and distributing the one or more subtasks across parallel and/or sequential processing pathways. Process 300 may be initiated following task classification and/or machine learning model selection as described in FIGS. 1B and 2. Process 300 may enable decomposition of complex queries into one or more subtasks and may enable subsequent subtask execution across multiple machine learning models to improve computation efficiency and/or output quality. In some implementations, this process may be orchestrated by a multi-agent framework (e.g., based on LangGraph and/or an atomic agent controller) that may be activated when multiple queries are present and the user enables multi-agent execution. For example, this processing may correspond to less than 8% of queries received.

At step 302, system 100 may identify, within the one or more queries, one or more dependent subtasks and one or more independent subtasks. The one or more dependent subtasks may correspond to sequential execution and the one or more independent subtasks may correspond to parallel execution. That is, the one or more independent subtasks may be interpreted as query components that can be handled in isolation without relying on the output of other components. In contrast, the one or more dependent subtasks may use the output of processing of another subtask as an input. Subtask identification may be based on semantic parsing, structural analysis, and/or learned patterns derived from historical inputs. For example, a compound query such as “Summarize the attached document and rephrase the summary in simpler terms” may be decomposed into two dependent subtasks: summarization followed by rewriting. For example, a query such as “Extract the main points from the three attached reports” may be decomposed into three independent subtasks, each corresponding to a separate report and routed for parallel processing.

At step 304, system 100 may route the one or more independent subtasks to a plurality of machine learning models, for example a plurality of task-specific machine learning models, for parallel processing. This parallel routing may optimize latency and/or system throughput by processing subtasks in parallel using separate inference paths. For example, if a user uploads multiple documents and asks for individual summaries of each, the summarization subtask for each document may be sent to a separate instance of a summarization machine learning model and/or to different machine learning models based on load balancing and/or document characteristics.

At step 306, system 100 may route the one or more dependent subtasks to one or more machine learning models, for example one or more task-specific machine learning models, for sequential processing. Such sequential processing may involve executing at least one of the one or more dependent subtasks based on an output generated from a prior dependent subtask. That is, the execution of a subsequent subtask may depend on the output of a preceding one. Such sequential processing may enable output chaining across subtasks. For example, if a query includes “Answer the following question based on the summary of the article and provide a simplified explanation of the answer,” the system may first generate the summary (subtask 1), use the summary as input to a question-answering model (subtask 2), and rephrase the answer in simpler terms using a rewriting model (subtask 3).

At step 308, system 100 may aggregate output responses from parallel and/or sequential subtask processing using a model aggregation system, optionally based on a multi-model Mixture-of-Experts system as described above, configured to combine outputs from multiple machine learning models based on task-specific criteria to generate a final output response. For example, if subtasks include both summarization and sentiment analysis of multiple sections of a report, the final output response may combine summaries and tonal assessments into a unified output. In other implementations, if different models return overlapping or conflicting outputs (e.g., conflicting named entities or different sentiment scores), the aggregation system may resolve conflicts based on predefined confidence thresholds and/or by apply weighting rules based on model specialization. The final output response may be delivered in natural language, structured data format, and/or as a multimodal composite, depending on system configuration and/or on the one or more queries.

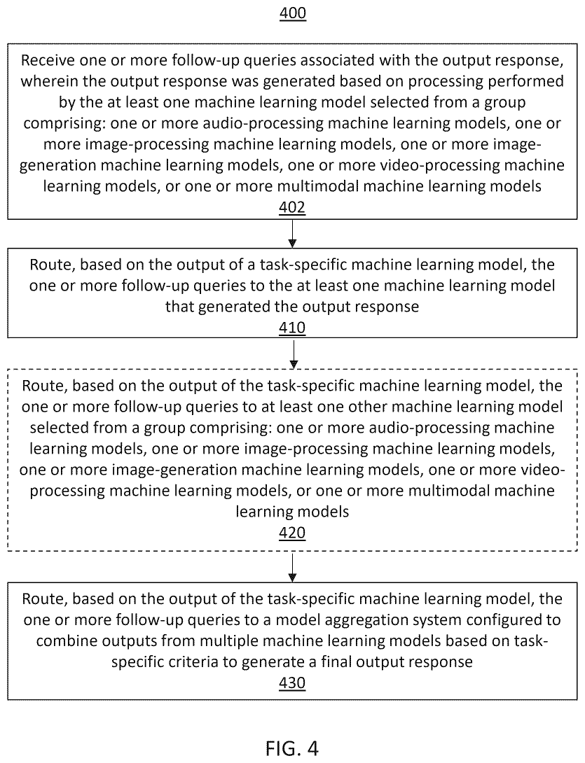

FIG. 4 depicts an exemplary process 400 for handling one or more follow-up queries associated with an output response previously generated by one or more machine learning models, for example one or more audio-processing machine learning models, one or more image-processing machine learning models, one or more image-generation machine learning models, one or more video-processing machine learning models, and/or one or more multimodal machine learning models. Process 400 may be performed by system 100 following a multimodal and/or non-text query routing event such as that described in step 142 of FIG. 1B. Process 400 may enable system 100 to maintain context, extend prior interactions, and/or refine and/or reprocess outputs by selecting the most appropriate machine learning model.

At step 402, system 100 may receive one or more follow-up queries that reference or build upon a prior output response. The prior response may have been generated based on processing performed by at least one machine learning model selected from a group including one or more audio-processing machine learning models, one or more image-processing machine learning models, one or more image-generation machine learning models, one or more video-processing machine learning models, and/or one or more multimodal machine learning models. In some implementations, the follow-up may be automatically linked to the previous query session through a session ID, conversational history, and/or metadata tagging. For example, a user may first submit an image with the prompt “Describe this scene,” and after receiving a description, submit a follow-up query such as “Now tell me the mood or emotion this image conveys.” In such a case, system 100 may treat the second query as a dependent continuation of the first and route it accordingly.

At step 410, system 100 may route the one or more follow-up queries to the same at least one machine learning model or model type that generated the original output response. This routing may be determined based on the output of a task-specific machine learning model that interprets the follow-up query and resolves whether continuity with the original processing path is appropriate. For example, the task-specific machine learning model may be a resource-efficient, small-scale machine learning model such as a small language model (e.g. Microsoft Phi-3-mini-128k-instruct, Mistral, LLaMa, and/or Falcon). For example, if the original image was processed by a vision-language model, and the follow-up asks for elaboration or clarification, the system may redirect the query back to that same model with updated instructions. This enables consistent interpretation across queries while preserving alignment with the original model's perspective and/or response format.

In some implementations, process 400 may optionally include step 420, at which the one or more follow-up queries may be routed to at least one other machine learning model selected from the above-described group of modality-specific and multimodal models based on the output from the above-described task-specific machine learning model. This may occur when the one or more follow-up queries represent a shift in modality and/or a different task category and/or escalate in complexity. For example, if a user originally submits a text document of extended length and requests a summary, then submits a follow-up query including the question “Which section provides the most compelling argument?”, the system may determine that processing the follow-up query may involve a machine learning model capable of rhetorical or sentiment-based textual analysis, for example a machine learning model distinct from the original document summarization model. Prior to providing the follow-up query to the at least one other machine learning model, system 100 may provide the previous query and/or previous conversation context to the at least one other machine learning model. For example, this previous query and/or previous conversation context may be provided in a compressed format. Thus, the rerouting associated with processing the follow-up query in this case may involve a shift from a general-purpose summarization model to a language model trained on argumentative structure or sentiment interpretation, enabling system 100 to address the follow-up query effectively.

At step 430, based on the output from the above-described task-specific machine learning model, system 100 may alternatively or additionally route the one or more follow-up queries to a model aggregation system configured to combine outputs from multiple machine learning models based on task-specific criteria. This may occur, for example, when processing a follow-up query involves cross-modal reasoning and/or synthesizing outputs from different task-specific machine learning models. As an example, a user may upload an instructional diagram and submit a first query asking for a textual description and a follow-up query including “Summarize what the diagram illustrates and generate three bullet points highlighting its key points.” In response, system 100 may use an image-processing machine learning model to identify and label key visual elements within the diagram, a text-generation machine learning model to describe the identified elements, and/or a summarization-processing machine learning model to generate the final output response. The model aggregation system may collect and weigh each machine learning model output, applying rules and/or learned heuristics to assemble a coherent final output response. In some implementations, the aggregation process may be managed by a multi-model Mixture-of-Experts (MoE) system that may evaluate model relevance, performance history, and/or task alignment in determining how to combine intermediate outputs.

In some implementations, the aggregation performed by the multi-model MoE system may follow a straightforward and intuitive approach. Rather than explicitly evaluating performance history or complex metrics during aggregation, the MoE may combine intermediate outputs by assigning adaptive weights directly aligned with the user's main query intent. For example, a user query may involve extracting specific details from both documents and images (handled separately by specialized models). The MoE may then intelligently aggregate these intermediate outputs, assigning greater weight to those results that most directly address the user's primary question. This may ensure that the final response precisely answers the user's primary query, rather than merely presenting disconnected results from multiple sources or subtasks.

In some implementations, despite an initial query being routed as a non-text input, if processing a follow-up query involves text processing, system 100 may provide the text-based input to a multi-model MoE system such as a Mixtral-based MoE system, optionally including the initial query and/or initial conversation context in a compressed format. Such a MoE system may be configured to handle multiple domains within a single architecture, enabling the system to process a range of follow-up queries in domains that may include, for example, legal, medical, technical, and/or general knowledge domains, without switching between separate machine learning models. This consolidation of expertise may allow system 100 to respond effectively to diverse follow-up requests without requiring an additional classification step, improving query response latency and/or contextual coherence. In contrast to general-purpose or fine-tuned LLMs, small language models (SLMs), and traditional task-specific models, an MoE system may activate only a subset of expert sub-models for each query. This architecture may enable specialization while maintaining computational efficiency, allowing system 100 to leverage targeted expertise without invoking the full capacity of a high-performance model.

In some implementations, the MoE system may be configured to assign one or more task-specific weights to the outputs from multiple machine learning models based on their relevance to an intent associated with one or more user queries, with a generated final output response based on the intent. This weighted aggregation may ensure that the generated final output response is not a simple combination of intermediate results but rather a synthesized response that directly addresses the user's main objective. For example, if a user query involves analyzing sales figures from a document and identifying specific products from an accompanying image, system 100 may separately extract numerical data using a document-processing model and identify objects using an image-processing model. The MoE system may then generate a unified textual answer to a follow-up query such as “Which product from the image had the highest sales growth according to the document?” by prioritizing and integrating outputs most aligned with the query's overall intent.

### Memory Management Strategy

The framework may utilize a structured and multi-layered memory architecture to ensure clarity, consistency, and precision in responses by carefully maintaining context.

Specifically, the memory storage approach may include modality-specific memory. Each modality—such as text, image, audio, document, or video—may have its dedicated contextual memory. This may ensure the preservation and utilization of relevant information specific to that data type during query processing. For instance, when handling a text-based query (such as summarizing a lengthy conversation or answering specific follow-up questions), the system may retrieve the most relevant historical information from a dedicated vectorized database (using semantic similarity matching, via embeddings). The system may incorporate recent interactions specifically related to the current modality (e.g., previous text queries and responses). The system may also factor in a balanced set of recent general interactions from the conversation, weighted by recency, to provide well-rounded context. For example, if a user asks a follow-up textual query such as “Summarize the key insights from the last document I uploaded,” the text model may receive relevant embeddings and summaries extracted from the document itself, context from prior text interactions specifically related to this document, and general recent conversational context from the past few interactions to accurately capture user intent. This three-fold modality-specific memory may ensure highly contextual and accurate responses tailored to each individual query type.

In some implementations, system 100 may be configured to enhance follow-up query handling by leveraging contextual information aligned with the modality of the follow-up input. For example, when routing one or more follow-up queries to a previously used machine learning model, system 100 may retrieve contextual information associated with the modality of the one or more follow-up queries. This contextual information may then be provided to the machine learning model that generated the original output response, allowing the model to maintain continuity and improve the relevance of its subsequent output. The contextual information associated with the modality of the one or more queries may include, but is not limited to a stored user query, a stored model response, stored metadata, and/or a stored semantic embedding. These elements may be retrieved from modality-specific memory or from a unified memory structure, as described above, enabling system 100 to deliver consistent, coherent, and context-aware responses across multi-turn and/or multimodal conversations.

In addition to modality-specific memories, the framework may maintain an overarching unified conversation memory. This comprehensive memory may aggregate contexts across all modalities, ensuring continuity when interactions span multiple data types (e.g., from audio transcription, to image analysis, and then to textual summary or query resolution). It may maintain coherent, seamless interaction flows across multimodal and multi-turn conversations. For example, if a user initially uploads an image, later references that image via a textual request (“Explain the objects detected in the image again”), and subsequently provides an audio clip referring back to the same scenario, the unified conversation memory may enable the system to recall and coherently link context from the image analysis, text-based clarification, and/or audio transcription seamlessly.

This dual-layer memory storage approach may enhance the overall user experience by ensuring high contextual continuity, reducing the cognitive load on the user (as there may be no need to repeatedly re-establish context), and providing consistently precise and context-aware outputs across multiple interactions and modalities. This dual-layer memory storage approach may distinguish disclosed systems and methods from other techniques, ensuring effective handling of both straightforward and complex multimodal interactions, thereby improving the accuracy and coherence of responses.

Additionally, by enabling selective and adaptive reuse of prior context (e.g., context that may be stored within modality-specific and/or unified memory layers), system 100 may reduce redundant data transfers and/or lower the computational and bandwidth burden on interconnected components and communication pathways, respectively. Because previously gathered contextual information may be stored and reused locally, there may be no need to rely on said interconnected components and bandwidth to re-establish context during follow-up or multi-turn interactions. This memory-driven optimization may thereby reduce processing overhead, support more efficient hardware utilization, and/or improve inference scalability across distributed environments. As a result, system 100 may improve system efficiency, lower latency, and/or enhance the accuracy of generated responses by providing machine learning models with targeted, contextually relevant information during query processing.

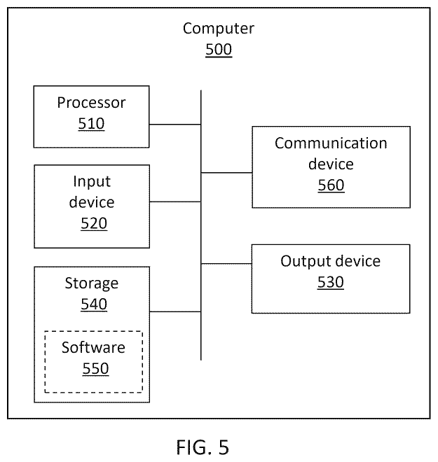

In one or more examples, the disclosed systems and methods utilize or may include a computer system. FIG. 5 depicts an exemplary computing system according to one or more examples of the disclosure. Computer 500 can be a host computer connected to a network. Computer 500 can be a client computer or a server. As shown in FIG. 5, computer 500 can be any suitable type of microprocessor-based device, such as a personal computer, workstation, server, or handheld computing device, such as a phone or tablet. The computer can include, for example, one or more of processor 510, input device 520, output device 530, storage 540, and communication device 560. Input device 520 and output device 530 can correspond to those described above and can either be connectable or integrated with the computer.

Input device 520 can be any suitable device that provides input, such as a touch screen or monitor, keyboard, mouse, or voice-recognition device. Output device 530 can be any suitable device that provides an output, such as a touch screen, monitor, printer, disk drive, or speaker.

Storage 540 can be any suitable device that provides storage, such as an electrical, magnetic, or optical memory, including a random-access memory (RAM), cache, hard drive, CD-ROM drive, tape drive, or removable storage disk. Communication device 560 can include any suitable device capable of transmitting and receiving signals over a network, such as a network interface chip or card. The components of the computer can be connected in any suitable manner, such as via a physical bus or wirelessly. Storage 540 can be a non-transitory computer-readable storage medium comprising one or more programs, which, when executed by one or more processors, such as processor 510, cause the one or more processors to execute methods described herein.

Software 550, which can be stored in storage 540 and executed by processor 510, can include, for example, the programming that embodies the functionality of the present disclosure (e.g., as embodied in the systems, computers, servers, and/or devices as described above). In one or more examples, software 550 can include a combination of servers such as application servers and database servers.

Software 550 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A system for routing queries to one or more machine learning models, the system comprising one or more processors and memory storing instructions that, when executed by the one or more processors, cause the system to:
receive one or more queries comprising at least one input selected from a group consisting of: a text-based input, an audio-based input, an image-based input, an image generation-based input, a video-based input, and a document-based input;
determine one or more classifications corresponding to the one or more queries, wherein the one or more classifications comprise at least one of:
a text classification, indicating that at least one of the one or more queries comprises a text-based input; or
a non-text classification, indicating that at least one of the one or more queries comprises at least one input selected from a group consisting of: an audio-based input, an image-based input, an image generation-based input, a video-based input, and a document-based input;
based on the determined one or more classifications, route the one or more queries to at least one of:
one or more text-processing machine learning models, wherein routing the one or more queries to the one or more text-processing machine learning models comprises selecting one of the text-processing machine learning models based on a complexity associated with the text-based input, one or more tasks associated with the text-based input, or both; or
at least one machine learning model selected from a group consisting of: one or more audio-processing machine learning models, one or more image-processing machine learning models, one or more image-generation machine learning models, one or more video-processing machine learning models, and one or more multimodal machine learning models; and
generate an output response based on processing performed by one or more machine learning models to which the one or more queries were routed.

2. The system of claim 1, wherein the instructions further cause the system to, prior to receiving one or more queries, receive a cost preference selection associated with processing the one or more queries, wherein the cost preference specifies at least one machine learning model selected from a group consisting of: one or more small-scale machine learning models, one or more high-performance machine learning models, and one or more task-specific machine learning models.

3. The system of claim 1, wherein routing the one or more queries further comprises selecting one or more machine learning models based on the determined one or more classifications and the received cost preference selection.

4. The system of claim 1, wherein selecting the one or more text-processing machine learning models comprises:
determining that the complexity associated with the text-based input meets a complexity threshold; and
in accordance with determining that the complexity associated with the text-based input meets the complexity threshold, selecting one or more high-performance machine learning models.

5. The system of claim 1, wherein selecting the one or more text-processing machine learning models comprises:
determining that the complexity associated with the text-based input does not meet a complexity threshold;
in accordance with determining that the complexity associated with the text-based input does not meet the complexity threshold:
assigning one or more weights to a plurality of machine learning models based on at least one parameter selected from a group consisting of: model performance, computational cost, and the one or more tasks associated with the text-based input; and
selecting the one or more text-processing machine learning models based on the one or more weights.

6. The system of claim 1, wherein the instructions further cause the system to determine the one or more tasks associated with the text-based input.

7. The system of claim 6, wherein determining the one or more tasks associated with the text-based input is based on an output from a task-specific machine learning model.

8. The system of claim 6, wherein determining the one or more tasks associated with the text-based input is based on one or more task categories associated with the text-based input.

9. The system of claim 8, wherein the one or more task categories comprise at least one task category selected from a group consisting of: summarization, translation, code generation, and mathematical reasoning.

10. The system of claim 8, wherein the instructions further cause the system to determine the one or more task categories associated with the text-based input based on one or more task-related keywords in the text-based input and one or more syntactic features of the text-based input.

11. The system of claim 6, wherein determining the one or more tasks associated with the text-based input comprises:
transforming the text-based input into one or more vector representations using a machine learning-based embedding model;
comparing the one or more vector representations to one or more vector representations corresponding to one or more task categories; and
determining one or more probabilities corresponding to the likelihood that the text-based input is associated with the one or more task categories.

12. The system of claim 11, wherein the one or more task categories comprise at least one task category selected from a group consisting of: summarization, translation, code generation, and mathematical reasoning.

13. The system of claim 1, wherein routing the one or more queries to the one or more text-processing machine learning models comprises:
identifying, within the one or more queries, one or more dependent subtasks and one or more independent subtasks, wherein the one or more dependent subtasks correspond to sequential execution and the one or more independent subtasks correspond to parallel execution;
routing the one or more independent subtasks to a plurality of task-specific machine learning models for parallel processing; and
routing the one or more dependent subtasks to one or more task-specific machine learning models for sequential processing, wherein at least one of the one or more dependent subtasks is executed based on an output generated from a prior dependent subtask.

14. The system of claim 13, wherein the instructions further cause the system to aggregate output responses generated by processing the one or more independent subtasks and the one or more dependent subtasks using a model aggregation system configured to combine outputs from multiple machine learning models based on task-specific criteria to generate a final output response.

15. The system of claim 14, wherein the model aggregation system is configured to assign one or more task-specific weights to the outputs from the multiple machine learning models based on relevance to an intent associated with the one or more queries, wherein the generated final output response is based on the intent.

16. The system of claim 1, wherein the instructions further cause the system to:
determine that one or more confidence scores associated with the routing of the one or more queries do not meet a confidence threshold; and
in accordance with determining that the one or more confidence scores do not meet the confidence threshold, reroute the one or more queries to one or more alternative machine learning models,
wherein the one or more alternative machine learning models are selected to provide higher performance relative to the originally routed one or more machine learning models.

17. The system of claim 1, wherein the instructions further cause the system to:
receive feedback indicating that the output response does not meet a satisfaction criterion; and
in accordance with receiving the feedback, reroute the one or more queries to one or more alternative machine learning models to generate a revised output response,
wherein the one or more alternative machine learning models are selected to provide higher performance relative to the originally routed one or more machine learning models.

18. The system of claim 1, wherein the instructions further cause the system to:
receive one or more follow-up queries associated with the output response, wherein the output response was generated based on processing performed by the at least one machine learning model selected from the group consisting of: the one or more audio-processing machine learning models, the one or more image-processing machine learning models, the one or more image-generation machine learning models, the one or more video-processing machine learning models, and the one or more multimodal machine learning models; and
route, based on the output of a task-specific machine learning model, the one or more follow-up queries to the at least one machine learning model that generated the output response.

19. The system of claim 18, wherein the instructions further cause the system to route, based on the output of the task-specific machine learning model, the one or more follow-up queries to at least one other machine learning model selected from the group consisting of: the one or more audio-processing machine learning models, the one or more image-processing machine learning models, the one or more image-generation machine learning models, the one or more video-processing machine learning models, or the one or more multimodal machine learning models.

20. The system of claim 18, wherein the instructions further cause the system to route, based on the output of the task-specific machine learning model, the one or more follow-up queries to a model aggregation system configured to combine outputs from multiple machine learning models based on task-specific criteria to generate a final output response.

21. The system of claim 18, wherein routing the one or more follow-up queries to the at least one machine learning model that generated the output response comprises:
retrieving contextual information associated with a modality of the one or more queries; and
providing the retrieved contextual information to the at least one machine learning model that generated the output response.

22. The system of claim 21, wherein the contextual information associated with the modality of the one or more queries comprises at least one element selected from a group consisting of: a stored user query, a stored model response, stored metadata, and a stored semantic embedding.

23. A method for routing queries to one or more machine learning models, the method performed by a system comprising memory and one or more processors, the method comprising:
receiving one or more queries comprising at least one input selected from a group consisting of: a text-based input, an audio-based input, an image-based input, an image generation-based input, a video-based input, and a document-based input;
determining one or more classifications corresponding to the one or more queries, wherein the one or more classifications comprise at least one of:
a text classification, indicating that at least one of the one or more queries comprises a text-based input; or
a non-text classification, indicating that at least one of the one or more queries comprises at least one input selected from a group consisting of: an audio-based input, an image-based input, an image generation-based input, a video-based input, and a document-based input;
based on the determined one or more classifications, routing the one or more queries to at least one of:
one or more text-processing machine learning models, wherein routing the one or more queries to the one or more text-processing machine learning models comprises selecting one of the text-processing machine learning models based on a complexity associated with the text-based input, one or more tasks associated with the text-based input, or both; or
at least one machine learning model selected from a group consisting of: one or more audio-processing machine learning models, one or more image-processing machine learning models, one or more image-generation machine learning models, one or more video-processing machine learning models, and one or more multimodal machine learning models; and
generating an output response based on processing performed by one or more machine learning models to which the one or more queries were routed.

24. A non-transitory computer readable storage medium storing instructions for routing queries to one or more machine learning models, wherein the instructions, when executed by one or more processors of an electronic device, cause the device to:
receive one or more queries comprising at least one input selected from a group consisting of: a text-based input, an audio-based input, an image-based input, and image generation-based input, a video-based input, and a document-based input;
determine one or more classifications corresponding to the one or more queries, wherein the one or more classifications comprise at least one of:
a text classification, indicating that at least one of the one or more queries comprises a text-based input; or
a non-text classification, indicating that at least one of the one or more queries comprises at least one input selected from a group consisting of: an audio-based input, an image-based input, an image generation-based input, a video-based input, and a document-based input;
based on the determined one or more classifications, route the one or more queries to at least one of:
one or more text-processing machine learning models, wherein routing the one or more queries to the one or more text-processing machine learning models comprises selecting one of the text-processing machine learning models based on a complexity associated with the text-based input, one or more tasks associated with the text-based input, or both; or
at least one machine learning model selected from a group consisting of: one or more audio-processing machine learning models, one or more image-processing machine learning models, one or more image-generation machine learning models, one or more video-processing machine learning models, and one or more multimodal machine learning models; and
generate an output response based on processing performed by one or more machine learning models to which the one or more queries were routed.
